(19) United States
(12) Patent Application Publication
(10) Pub. No.: US 2005/0064278 A1
(43) Pub. Date: Mar. 24, 2005

(54) Method for cold-starting batteries

(76) Inventors: Michael A. Fetcenko, Rochester, MI (US); John Koch, Brighton, MI (US); Benjamin Reichman, West Bloomfield, MI (US)

Correspondence Address: Philip H. Schlazer;Energy Conversion Devices, Inc., 2956 Waterview Drive, Rochester Hills, MI, 48309, US

(21) Appl. No.: 10/666,089

(22) Filed: Sep. 19, 2003

(51) Int. Cl. H01M 10/50

(52) U.S. Cl. 429/50; 429/62

(57) ABSTRACT

A method of starting a nickel metal hydride battery in cold weather. The method includes the step of discharging the battery through a short circuit.

### FIELD OF THE INVENTION

The instant invention relates generally to nickel-metal hydride batteries. In particular the instant invention is related to a method of increasing the internal temperature of a nickel-metal hydride battery.

### BACKGROUND OF THE INVENTION

Rechargeable electrochemical cells may be classified as “nonaqueous” cells or “aqueous” cells. An example of a nonaqueous electrochemical cell is a lithium-ion cell which uses intercalation compounds for both anode and cathode, and a liquid organic or polymer electrolyte. Aqueous electrochemical cells may be classified as either “acidic” or “alkaline”. An example of an acidic electrochemical cell is a lead-acid cell which uses lead dioxide as the active material of the positive electrode and metallic lead, in a high-surface area porous structure, as the negative active material. Examples of alkaline electrochemical cells are nickel cadmium cells (Ni—Cd) and nickel-metal hydride cells (Ni-MH).

Ni-MH cells use negative electrodes having a hydrogen absorbing alloy as the active material. The hydrogen absorbing alloy is capable of the reversible electrochemical storage of hydrogen. Ni-MH cells typically use a positive electrode having nickel hydroxide as the active material. The negative and positive electrodes are spaced apart in an alkaline electrolyte such as potassium hydroxide.

Upon application of an electrical potential across a nickel metal hydride cell, the hydrogen absorbing alloy active material of the negative electrode is charged by the electrochemical absorption of hydrogen and the electrochemical discharge of a hydroxyl ion, forming a metal hydride. This is shown in equation (1): 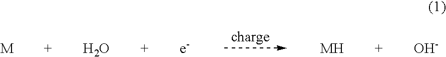
Likewise during charge, the reactions that take place at the positive electrode are shown in equation (2) where the nickel hydroxide is converted to nickel oxyhydroxide.

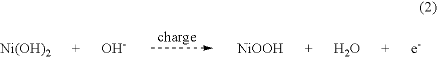

The reactions at the negative and positive electrodes are reversible. At the negative electrode, upon discharge, the stored hydrogen is released from the metal hydride to form a water molecule and release an electron. At the positive electrode, the nickel oxyhydroxide is converted back to the nickel hydroxide. This is shown in equation (3) and equation (4):

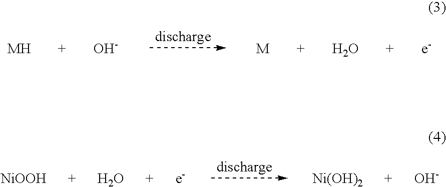

Certain hydrogen absorbing alloys result from tailoring the local chemical order and local structural order by the incorporation of selected modifier elements into a host matrix. Disordered hydrogen absorbing alloys have a substantially increased density of catalytically active sites and storage sites compared to single or multi-phase crystalline materials. These additional sites are responsible for improved efficiency of electrochemical charging/discharging and an increase in electrical energy storage capacity. The nature and number of storage sites can even be designed independently of the catalytically active sites. More specifically, these alloys are tailored to allow bulk storage of the dissociated hydrogen atoms at bonding strengths within the range of reversibility suitable for use in secondary battery applications.

Some extremely efficient electrochemical hydrogen storage alloys were formulated, based on the disordered materials described above. These are the Ti—V—Zr—Ni type active materials such as disclosed in U.S. Pat. No. 4,551,400 (“the '400 Patent”) the disclosure of which is incorporated herein by reference. These materials reversibly form hydrides in order to store hydrogen. All the materials used in the '400 Patent utilize a generic Ti—V—Ni composition, where at least Ti, V, and Ni are present and may be modified with Cr, Zr, and Al. The materials of the '400 Patent are multiphase materials, which may contain, but are not limited to, one or more phases with C₁₄ and C₁₅ type crystal structures.

Other Ti—V—Zr—Ni alloys, also used for rechargeable hydrogen storage negative electrodes, are described in U.S. Pat. No. 4,728,586 (“the '586 Patent”), the contents of which is incorporated herein by reference. The '586 Patent describes a specific sub-class of Ti—V—Ni—Zr alloys comprising Ti, V, Zr, Ni, and a fifth component, Cr. The '586 Patent, mentions the possibility of additives and modifiers beyond the Ti, V, Zr, Ni, and Cr components of the alloys, and generally discusses specific additives and modifiers, the amounts and interactions of these modifiers, and the particular benefits that could be expected from them. Other hydrogen absorbing alloy materials are discussed in U.S. Pat. Nos. 5,096,667, 5,135,589, 5,277,999, 5,238,756, 5,407,761, and 5,536,591, the contents of which are incorporated herein by reference.

Nickel-metal hydride batteries are used in many different applications. For example, nickel-metal hydride batteries are used in numerous consumer devices such as calculators, portable radios, and cellular phones. They are also used in many different vehicle applications. For example, nickel-metal hydride batteries are used to drive both pure electric vehicles (EV) as well as hybrid electric vehicles (HEV). Hybrid electric vehicles utilize the combination of a combustion engine (where “combustion engine” refers to engines running off of any known fuel, be it hydrogen or hydrocarbon based such as gasoline, alcohol, or natural gas, in any combination) and a battery powered electric motor. In a “series” type HEV the battery powered motor drives the vehicle while the combustion engine is used to recharge the battery. In a “parallel” type HEV, both the combustion engine and the electric motor drive the vehicle. It is possible that the means of propulsion may be selected by an operator or a computer system. In certain types of HEVs (such as “range extenders”), a battery powered motor is primarily used for propulsion while the engine is used for peak loads and/or for recharging the battery. In other types of HEVs (such as “power assist”), the engine is primarily used for propulsion and recharging the battery while peak loads are handled by the electric motor.

HEVs are preferably “charge sustaining” whereby the battery is recharged during use in the vehicle through regenerative braking and also by means of electric power supplied from a generator driven by the engine so that the charge of the battery is maintained during operation. Hence, for HEV propulsion applications nickel-metal hydride batteries should be designed to provide high pulse power while at the same time accepting high regenerative braking currents at very high efficiency. Gravimetric and volumetric power density of the battery are thus important considerations. The cycle life of the battery at 30-60% DOD is also more critical than cycle life at 80% DOD as required in EV applications.

Nickel-metal hydride batteries also have many “non-propulsion” applications in both battery driven as well as non-battery driven vehicles. For example, nickel-metal hydride batteries may be used for starting, lighting and ignition applications.

For certain application's, such as starting, the output power of the battery at cold temperatures is important. Typically, the output power of a nickel-metal hydride battery is adversely affected by cold weather. The present invention is directed to a method of increasing the internal temperature of the battery by using the battery's own energy.

### SUMMARY OF THE INVENTION

One aspect of the present invention is a method of operating a nickel-metal hydride battery, comprising: providing a nickel-metal hydride battery; determining the ambient temperature of the battery; and setting the state of change of the battery, the state of charge at least partially dependent upon the ambient temperature.

Another aspect of the present invention is a method of operating a nickel-metal hydride battery, comprising: providing the nickel-metal hydride battery having a temperature of −20° C. or less; and converting a portion of the chemical energy of said battery to thermal energy.

Another aspect of the present invention is a method of operating a nickel-metal hydride battery to apply power to a load, comprising the steps of: providing the nickel-metal hydride battery; applying a short circuit across the terminals of the battery for a finite period of time; after applying the short circuit, electrically coupling the battery to the load.

### BRIEF DESCRIPTION OF THE DRAWINGS

FIG. 1 shows a cross-sectional view of a prismatic electrochemical cell;

FIG. 2 is a simplified schematic diagram of an electrochemical cell showing the internal resistance of the cell as well as a load resistance;

FIG. 3 shows the voltage as a function of time of a nickel-metal hydride electrochemical cell as different ambient temperatures;

FIG. 4A shows the amplitude of a discharge current pulse as a function of time;

FIG. 4B shows the skin temperature of a nickel-metal hydride electrochemical cell as a function of time;

FIG. 5 shows the voltage as a function of time for a nickel-metal hydride electrochemical cell as different states of charge;

FIG. 6 shows an example of how battery state of charge may be set as a function of temperature; and

FIG. 7 shows an example of how battery state of charge may be set as a function of temperature;

FIG. 8 shows an example of how battery state of charge may be set as a function of temperature; and

FIG. 9 shows how a short circuit may be applied across a battery that is also selectively coupled to a load.

### DETAILED DESCRIPTION OF THE INVENTION

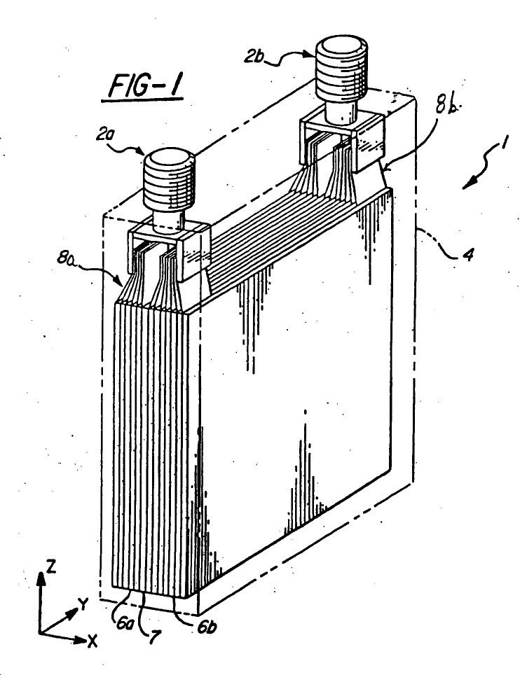

FIG. 1 is a cross-sectional view of an example of a prismatic nickel-metal hydride electrochemical battery cell 1. The battery cell 1 includes one or more negative electrodes 6a as well as one or more positive electrodes 6b. Each of the negative electrodes includes a hydrogen storage alloy active material. The hydrogen storage alloy active material is disposed on a conductive substrate which serves as a mechanical support as well as a current collector. Examples of conductive substrates include expanded metal, perforated metal, screen and metal foam. For the negative electrode, the substrate is preferably an expanded metal. A negative electrode tab 8a is attached to each of the negative electrodes 6a. Preferably, the negative electrode tab 8a is welded to the substrate of the negative electrode. The negative electrode tabs 8a are attached to the negative terminal 2b of the electrochemical cell 1. Preferably, the tabs 8a are welded to the terminal 2a. Welding may be any welding process known in the art. It includes, but is not limited to, laser welding and acoustical welding.

The electrochemical cell 1 further includes one or more positive electrodes 6b. Each of positive electrodes 6b includes a nickel hydroxide active material which is disposed onto a conductive substrate (preferably in the form of a paste). For the positive electrodes 6b, the substrate is preferably a metal foam. The metal foam is preferably formed from metallic nickel or a nickel alloy. A positive electrode tab 8b is attached to each of the positive electrodes 6b. Preferably, the positive electrode tab is welded to the positive electrode substrate. The positive electrode tabs 8b are connected to a positive terminal 2b for the electrochemical cell 1. Preferably, the tabs are welded to the terminal. The negative and positive electrodes are spaced apart by separators 7. The negative electrodes, positive electrodes and separators are disposed in a battery container 4 and are surrounded and wetted by a battery electrolyte. For a nickel-metal hydride battery, the electrolyte used is preferably an alkaline electrolyte. Preferably, the alkaline electrolyte is an aqueous solution of an alkali metal hydroxide. The alkali metal hydroxide may be potassium hydroxide, lithium hydroxide, sodium hydroxide or mixtures thereof. Preferably, the alkali metal hydroxide is potassium hydroxide.

A plurality of nickel-metal hydride electrochemical cells may be coupled is series and/or parallel to form a module. Likewise, a plurality of modules may be coupled in series and/or parallel to form a pack. As used herein the term “battery” may refer to either a single electrochemical cell, or it may refer to a plurality of electrochemical cells that are coupled together (in either series and/or parallel) to form a module, or it may refer to a plurality of modules that are coupled together (in either series and/or parallel) to form a pack.

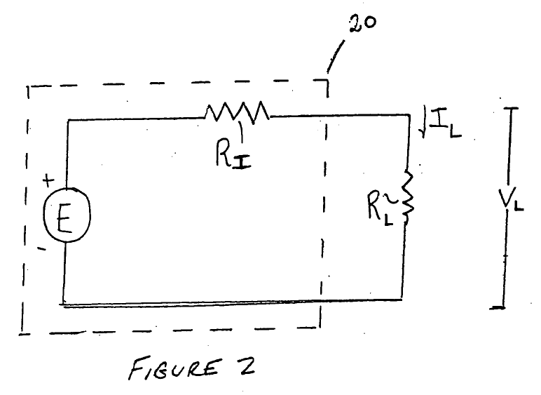

FIG. 2 shows a simplified schematic diagram of an electrochemical cell connected to an external load R_{L}. The electrochemical cell can be represented as a “black box” 20 containing an EMF source E and a series internal resistance R_{I}.

The external load R_{L} is variable and may be altered from zero resistance to infinite resistance. When the load resistance R_{L} is infinite, the current I_{L} through the load R_{L} is zero and the voltage V_{L} across the load is maximum at V_{OC} (open circuit). Also, when the load R_{L} is zero resistance, the voltage V_{L} across the load is zero and the current I_{L} is at a maximum Iₘₐₓ.

The resistance R_{I} represents the total internal resistance of the battery. The total internal resistance R_{I} includes the ohmic resistance of the internal parts of the battery. This includes the ohmic resistances of the positive and negative battery terminals, the positive and negative electrode tabs, the positive and negative conductive substrates, the positive and negative active electrode materials, the separators and the electrolyte. Hence, the total internal resistance R_{I} includes the ohmic resistances of each of the individual parts of the electrochemical cell.

In addition to the ohmic resistances of the internal parts of the cell, the total internal resistance R_{I} of the cell also includes the reaction resistance of the negative and positive active electrode materials. The reaction resistance will be described in more detail below.

The power P_{L} applied to the load is the product of the voltage V_{L} across the load and current I_{L} through the load. The power P_{L} is thus zero when either the voltage V_{L} or the current I_{L} are zero. The power reaches a maximum when the voltage V_{L} across the load equals V_{OC}/2 and the current I_{L} equals Iₘₐₓ/2.

The power P_{L} applied to the load R_{L} by the nickel-metal hydride cell is adversely affected by cold temperatures. As the ambient temperature decreases, so does the temperature of the battery cell components. This causes the total internal resistance R_{I} of the cell as well as the voltage drop V_{I} across the internal resistance R_{I} to increase. Since, the total voltage E of the cell is fixed, the voltage V_{L} across the load R_{L} decreases. Hence, the voltage V_{L} across the load R_{L} as well as the power P_{L} applied to the load decreases with decreasing ambient temperature.

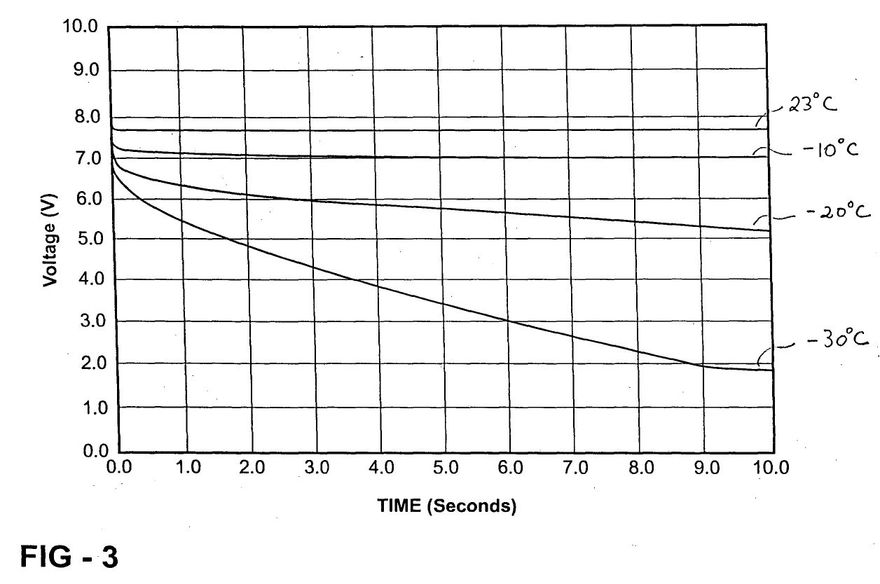

FIG. 3 is an example which shows the effect of ambient temperature on the output voltage V_{L} (measured in volts) of a nickel-metal hydride electrochemical cell. In the example shown, a nickel-metal hydride cell (at a 50% state of charge) is discharged at a 10C rate for 10 seconds. The cell is discharged for 10 seconds at ambient temperatures of 23° C. (room temperature), −10° C., −20° C. and −30° C. The graphs showing discharge at ambient temperatures of 23° C., −10° C., −20° C., −30° C. are labeled “23° C.”, “−10° C.”, “−20° C.”, “−30° C.”, respectively.

Referring to the graphs of FIG. 3, it is seen that the output voltage of the cell is affected by the ambient temperature of the cell. As the ambient temperature decreases, the output voltage of the cell decreases throughout the discharge period. At longer discharge times, the drop in the output voltage becomes greater and greater with decreasing ambient temperature. Referring to FIG. 3, it is seen that prior to discharge (at time=0.0), the output voltage of the electrochemical cell varies very little with ambient temperature. However, after 10 seconds of discharge there is a significant difference between the cell output voltage at ambient temperatures of 23° C. (room temperature), −10° C., −20° C. and −30° C.

Specifically, it is seen that after 10 seconds of discharge the output voltage at 23° C. has changed very little. However, at −10° C. the output voltage has decreased to about 7 volts, at −20° C. the output voltage has decreased to about 5 volts and at −30° C. the output voltage has decreased to about 2 volts.

While not wishing to be bound by theory, it is believed that the dominant resistance of the cell at cold temperatures is the resistance of the hydrogen storage alloy active material. That is, as the temperature of the cell decreases, the resistance of the hydrogen storage alloy material and, in particular, the resistance of the hydrogen storage alloy oxide surface layer, increases and becomes the dominant internal resistance of the electrochemical cell.

The resistance of the hydrogen storage alloy material has several different components. The resistance of the hydrogen storage alloy includes an ohmic resistance. The resistance of the hydrogen storage alloy also includes reaction resistance. The reaction resistance includes the charge transfer resistance, ionic pore resistance and diffusion resistance.

The charge transfer resistance of the hydrogen storage alloy is also referred to as the kinetic resistance of the material. The charge transfer resistance is the resistance to electron transfer between the hydrogen storage alloy and the electrolyte at the surface of the hydrogen storage alloy. The charge transfer resistance is a measure of the surface catalytic activity of the hydrogen absorbing alloy and, in particular, of the surface catalytic activity of the hydrogen storage alloy surface oxide layer. Generally, the charge transfer resistance increases as the cell temperature decreases.

As noted above, another component of the reaction resistance of the hydrogen storage alloy is the “ionic pore resistance”. The ionic pore resistance is the resistance to the migration of the charged particles of the electrolyte (for example, of the OH⁻ ions) through the pores of the hydrogen storage alloy material. The hydrogen storage alloy includes pores (that is, channels and passageways) that exist between different particles of the hydrogen storage alloy material. The material also includes pores that exist within each individual particle of hydrogen storage material (and especially within the surface oxide of each particle of hydrogen storage material). Generally, the ionic pore resistance increases as the electrochemical cell temperature decreases.

Yet another component of the reaction resistance of the hydrogen storage material is the “diffusion resistance”. The diffusion resistance is the resistance of hydrogen specie through the bulk of the hydrogen storage material. The resistance of the hydrogen storage alloy material is also at least partially due to the rate of diffusion of hydrogen specie through the bulk of each of the hydrogen storage alloy particles. Generally, as the temperature of the cell decreases, the rate of hydrogen diffusion through the bulk of the material decreases, thereby increasing the total reaction resistance of the hydrogen storage alloy material. The contribution of diffusion resistance to the total reaction resistance of the hydrogen storage material typically increases as the state of charge of the hydrogen storage material decreases.

As the battery temperature decreases, the ohmic resistance as well as the reaction resistance (including the kinetic resistance, ionic pore resistance and the diffusion resistance) of the hydrogen storage alloy material each may at least partially contribute to the increase in the internal resistance of the electrochemical cell. However, it is believed that the increase in the reaction resistance may be the dominating factor contributing to loss in output power at cold temperatures. Increases in charge transfer resistance, ionic pore resistance as well as diffusion resistance may each contribute to the increase in the reaction resistance of the hydrogen storage alloy material at low temperatures. While not wishing to be bound by theory, it is believed that at low discharge currents, the charge transfer resistance may be the dominating component; at medium currents, the ionic resistance may be the dominating component; and at high currents, diffusion resistance may be the dominating component.

One aspect of the present invention that of converting the battery's stored chemical energy to heat energy that can be used to heat the battery so as to reduce its reaction resistance. A battery's chemical energy may be converted to heat energy by discharging the battery. The nickel-metal hydride battery, even at cold temperatures of about −20° C. or less, −25° C. or less, and even about −30° C. or less, may be discharged by placing a load of sufficiently small resistance across the positive and negative terminals of the battery. The resistance of this low resistance load may be negligible so that placing the load across the battery effectively short circuits the battery to allow the battery to partially discharge. If the battery is in the form of a single electrochemical cell, then this low resistance load may be placed across the positive and negative terminals of the cell. If the battery is in the form of a module, then this low resistance load may be placed across the positive and negative terminals of the module, or a current pathway may be placed across the positive and negative terminal of one or more of the cells. If the battery is in the form of a pack, then a low resistance load may be placed across the positive and negative terminals of the pack, or a load may be placed across the positive and negative terminals of one or more of the modules, or a low resistance load may be placed across the positive and negative terminals of one or more cells.

The low resistance load may be a conductive material having a resistance small enough to allow discharge to occur. For example, the load may be a metal wire or bar (where the metal may be a pure metal or alloy). For example, a metal wire or bar formed of copper, copper alloy, silver or silver alloy may be used. By applying the conductive material across the positive and negative terminals of the battery, the positive and negative terminals are short-circuited together. When the positive and negative terminals are short circuited, the battery cell discharges.

During discharge (as seen from equations (3) and (4) above), at the negative electrode the stored hydrogen is released from the hydrogen storage alloy to form a water molecule and release an electron. At the positive electrode, the nickel oxyhydroxide is converted back to the nickel hydroxide. During discharge of the electrochemical cell, the chemical energy storage in the active battery materials is converted to electrical energy. The electrical energy is in the form of electrical charge which flows through the internal components of the battery as well as through an external load. As the electrical current moves through the internal components of the battery, a portion of the electric potential energy of the electric charge is converted to thermal energy. On a microscopic scale this can be understood as collisions between electrons and the material of the battery components. This effect is referred to as Joule heating. The rate of transfer of electrical energy to thermal energy is directly proportional to the resistance of the material of the battery component. Increasing the electrical resistance of the material of a battery component increases the rate at which heat energy is formed from the electrical energy.

As noted, discharging an electrochemical cell causes electron flow through the cell components including the hydrogen storage alloy active material. In particular, the electrons flow through the bulk of the hydrogen storage alloy material as well as through the surface oxide of the hydrogen storage material. The electron flow causes Joule heating within the bulk and surface oxide of the hydrogen storage material, thereby raising the temperature of both the bulk and surface oxide. The thermal energy generated by the Joule heating within the hydrogen storage material flows into the pores and channels of the hydrogen storage material, thereby also raising the temperature of the electrolyte within the pores and channels. Hence, shorting the terminals of the cell (or module or pack) allows the cell to discharge, thereby converting a portion of its own internal chemical energy to electrical energy. The electrical energy is then converted to thermal energy which is used to heat and raise the temperature of the internal components. As the temperature of the internal components goes up, the internal resistances decrease. In particular, as the temperature goes up, the reaction resistance of the hydrogen storage alloy decreases. (Hence, the charge transfer resistance and/or ionic pore resistance and/or the diffusion resistance of the alloy decreases with increased battery temperature).

As the reaction resistance decreases, the total internal resistance R_{I} of the battery decreases. More of the battery's voltage and power are thus available to be applied to the battery's output load. The higher output voltage and power may be used for various applications, such as for starting a vehicle.

Short-circuiting the terminals of the battery may be accomplished manually by an operator. For example, if an operator tries to start the vehicle in cold weather (low ambient temperature) but is unable to do so, then there can be another switch that the operator can activate that will short-circuit the battery. After the battery is short-circuited for a period of time, the operator can again attempt to start the vehicle. Alternately, the vehicle electronics can short circuit the battery automatically after sensing a need to do so. Alternately, the battery can be shorted automatically by an electronic control system that senses the ambient temperature and automatically short-circuits the battery prior to starting the vehicle.

Preferably, the short circuit is applied across the terminals for a relatively short period of time. Preferably, the short circuit is applied for a time period less than about 15 seconds, most preferably less than about 10 seconds and, most preferably, less than about 5 seconds.

The amount of temperature increase depends upon the length of time in which the short circuit is applied. This corresponds to the length of time at which the battery is forced to discharge. The amount of temperature increase also depends upon the choice of the hydrogen storage alloy used.

A simplified circuit diagram illustrating a possible scheme to short-circuit the battery is shown in FIG. 9. FIG. 9 shows a battery 200 coupled to a load 210. The load 210 may have a resistive element and/or a capacitive element and/or an inductive element. The load 210 may represent, for example, a starting/ignition circuitry for a vehicle. When switch 220 is closed, the battery 200 is electrically coupled to the load 210. If the ambient temperature is too low, then the battery 200 may not have the output power to drive the load 210 and the vehicle may not start. If this is the case, then switch 230 may be closed (preferably while leaving switch 220 open) to short-circuit the battery for a sufficient period of time in order to heat the battery 200. After the battery is sufficiently heated to increase its output power, switch 230 is opened. Switch 220 is then closed to apply the output power to load 220 so that the vehicle may be started.

### EXAMPLE 1

A nickel-metal hydride battery cell comprising metal hydride negative electrodes, nickel hydroxide positive electrodes and a potassium hydroxide electrolyte is first cooled so that the temperature of the electrochemical cell (measured as the skin temperature of the cell) is at −30° C. The battery cell, at 80% state of charge, is then discharged at a rate which is preferably between about 40C. to about 60C. The battery is preferably discharged for a time period of about 10 seconds. The discharge pulse simulates a short circuit.

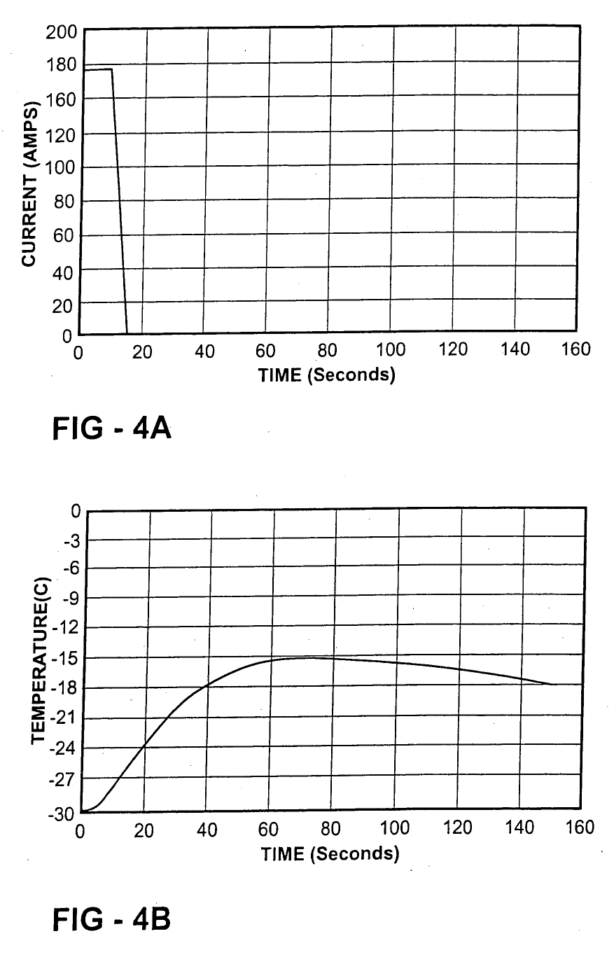

In the example shown in FIG. 4A, the battery is discharged at about 180 amps for a time-period of about 10 seconds.

FIG. 4B is a plot of the skin temperature of the battery cell as a function of time. FIG. 4B shows that, as a result of the discharge pulse, the outside skin temperature of the battery cell increases from about −30° C. to about −15° C. in about 60 seconds.

Table 1 shows the effect of the discharge pulse on the output power of the cell. The output power of the electrochemical cell may be calculated using a dual pulse method. That is, the battery cell is discharged at discharge rates of C and 10C, and the corresponding voltages are measured. Row 1 of Table 1 shows the result of the test using discharge pulses having a period of 10 seconds. Row 2 of Table 1 shows that result of the test using discharge pulses having a period of 20 seconds. The left column shows the specific power of electrochemical cell before the high current discharge pulse is applied while the right column shows the specific power of the electrochemical cell after the high current discharge pulse is applied.

TABLE 1

| | before discharge pulse | after discharge pulse |
|---|---|---|
| | (W/kg) | (W/kg) |
| Row 1 | 0 | 166 |
| Row 2 | 0 | 249 |

The left column shows the output power of the cell that has not been discharged with the current pulse. The output power is 0 regardless of the dual pulse test method (10 seconds—Row 1, or 20 seconds—Row 2) used. The right column shows the output power of the cell after a 180 Amp, 10 second discharge pulse has been applied. The output power of the cell is 166 Watts/kg as measured using the 10 second dual pulse method (Row 1) and 249 Watts/kg as measured using the 20 second dual pulse method (Row 2).

As noted above, the amount of change in the skin temperature of the electrochemical cell as well as the amount of increase in the output power of the cell as a result of discharging the cell at least partially depends upon the hydrogen storage alloy used in the nickel-metal hydride electrochemical cell. Hence, batteries incorporating different hydrogen storage alloy active electrode materials may show different results.

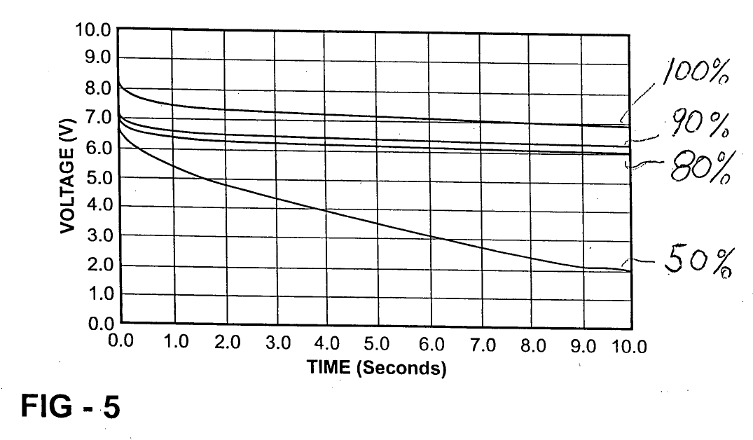

The output power of a nickel-metal hydride electrochemical cell at cold temperatures is related to the state of charge (SOC) of the cell. FIG. 5 shows the effect of the state of charge on the cell output voltage at an ambient temperature of −30° C. The cell is discharged at a rate of 10C for a time period of 10 seconds. As seen from FIG. 5, the output voltage of the cell after the 10 seconds of discharge is directly related to the initial state of charge of the cell. For example, when the electrochemical cell is initially at 50% state of charge, the output voltage of the cell is about 2 volts after 10 seconds of discharge. However, when the cell is initially at 80% state of charge (graph labeled “80%”), the output voltage is about 6 volts after 10 seconds of discharge. When the cell is initially at 90% state of charge (graph labeled “90%”), the output voltage is above 6 volts after 10 seconds of discharge. Also, when the cell is initially at about 100% state of charge (graph labeled “100%”), then the output voltage is at about 7 volts after 10 seconds of discharge.

The graphs of FIG. 5 show that the electrochemical cell output voltage, even at cold temperature, is directly dependent upon the state of charge of the cell. Hence, the output voltage may be controlled by adjusting the state of charge. Moreover, the graphs also show that the cell output voltage, and hence the output power, may be made sufficiently high (even at a temperature of −30° C.) to start a vehicle in cold weather by increasing the state of charge of the battery used to start the vehicle.

Hence, an approach to providing the necessary power in cold weather to start a vehicle is to change the state of charge of the battery to compensate for the ambient temperature.

Typically, a nickel-metal hydride battery used for driving a hybrid electric vehicle is kept at a state of charge of about 50%. The reason for this is due to regenerative braking. In a typical vehicle running only on an internal combustion engine, braking energy is lost as friction. However, in a hybrid electric vehicle, the braking energy is used to charge the battery. Hence, the battery must be able to accept regenerative braking energy. A nickel-metal hydride battery can best accept regenerative braking energy when the battery is at about 50% state of charge. The battery must be sufficiently empty to have an “energy reservoir” that is capable of accepting regenerative braking energy. As the state of charge is increased above 50%, the battery's ability to accept regenerative braking energy decreases. However, as the state of charge is increased above 50%, the battery's ability to start the vehicle in cold weather increases. Hence, there is a tradeoff between the battery's ability to start the car at cold temperatures and the battery's ability to accept regenerative braking energy.

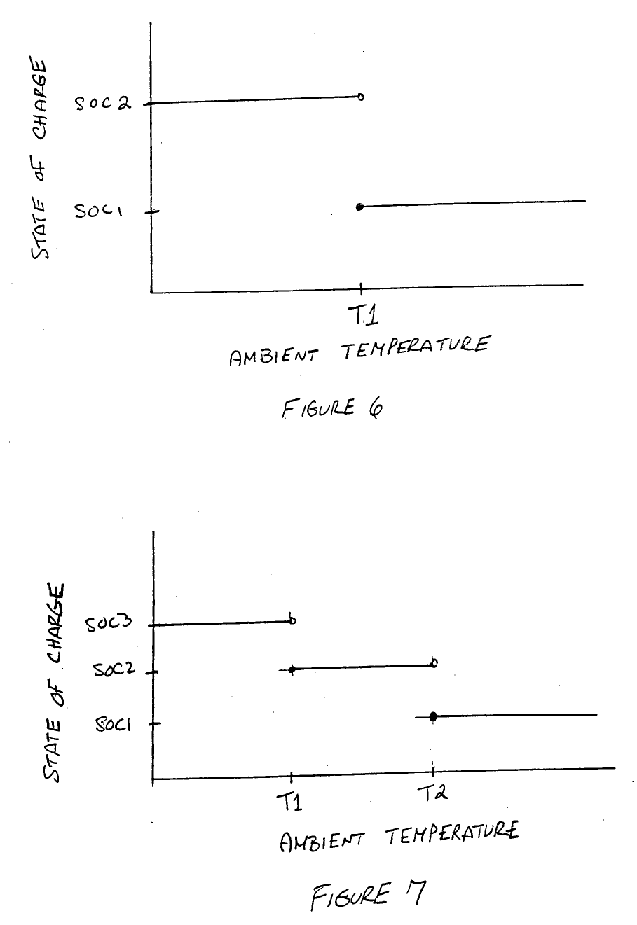

Hence, one approach to cold-weather starting is to change the state of charge of the battery during cold-weather conditions. A controller (such as a microprocessor) may be used to read the ambient temperature of the battery. Based upon the ambient temperature of the battery cell, the controller will then set the state of charge of the battery. For example, if the ambient temperature of the battery is below a first selected temperature (for example, the first selected temperature may be a temperature of about −30° C. or less), then the state of charge of the battery may be increased to a “high level”. The “high level” state of charge would be chosen to be a state of charge sufficient to provide an output voltage and output power necessary to start the vehicle. For example, this “high level” state of charge is preferably greater than 70% and is more preferably between about 70% and 90% SOC. An example of a “high level” state of charge is 80% SOC. If the ambient temperature of the battery cell goes above a second selected temperature (where the second selected temperature is greater than or equal to the first selected temperature), then the state of charge of the battery may be decreased to a “low level” state of charge which better accommodates acceptance of regenerative braking energy. The “low level” state of charge is preferably less than about 60% SOC and is more preferably between about 40% and about 60% SOC. An example of a “low level” state of charge may be a state of charge of about 50% SOC. An example of this type of scheme is shown in FIG. 6 which shows the battery state of charge (SOC) as a function of ambient temperature. If the ambient temperature is greater than T1, then the state of charge is set to SOC1 (which may be around 50%). If the ambient temperature is less than T1, then the state of charge is set to SOC2 (which may be around 80%). In the example shown in FIG. 6, if the ambient temperature is at T1, then the state of charge may is set to SOC1, however, in an alternate embodiment, it may be set to SOC2.

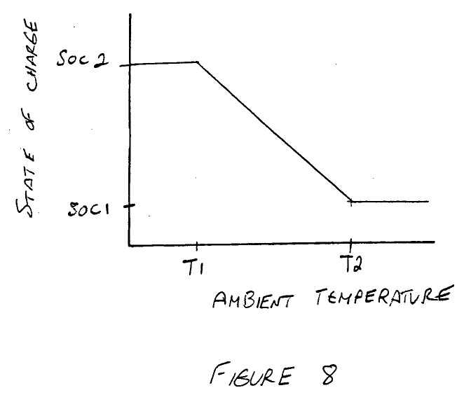

Other types of relationships between state of charge and ambient temperature are also possible. For example, the relationship between state of charge and temperature may be in the form of two or more steps such as shown in FIG. 7. In this case, if the ambient temperature is at or above T2, then the state of charge is set to SOC1; if the ambient temperature is greater than or equal to T1 but less than T2, then the state of charge is set to SOC2 (which is greater than SOC1); and if the ambient temperature is less than T1, then the state of charge is set to SOC3 (which is greater than SOC1).

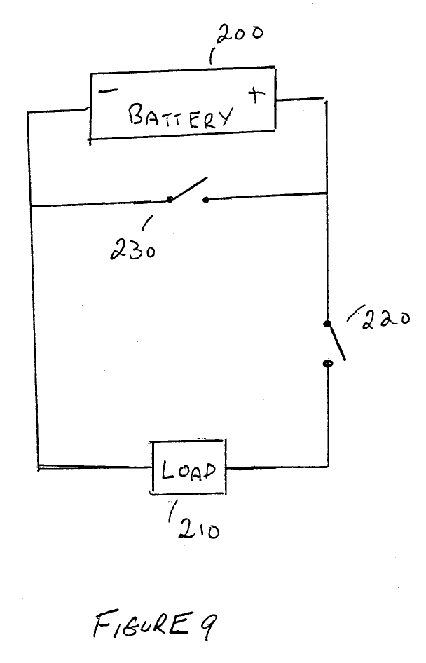

Another type of relationship is shown in FIG. 8, where, for at least a portion of the ambient temperature range between T1 and T2, the battery state of charge is made to decrease continuously with increasing ambient temperature. In the example shown in FIG. 8, the state of charge decreases to SOC1 as the ambient temperature increases to T2. Likewise, the state of charge increases to SOC2 (which is greater than SOC1) as the ambient temperature decreases to T1.

It is noted that if a vehicle operator knows that he or she is going to store a car for a long time and there was a possibility of starting the car during cold weather, then the state of charge may be manually set to a specific state of charge sufficient, for example, to start the vehicle.

It is to be understood that the disclosure set forth herein is presented in the form of detailed embodiments described for the purpose of making a full and complete disclosure of the present invention, and that such details are not to be interpreted as limiting the true scope of this invention as set forth and defined in the appended claims.

1. A method of operating a nickel-metal hydride battery, comprising:
providing a nickel-metal hydride battery;
determining the ambient temperature of said battery; and
setting the state of charge of said battery, said state of charge at least partially dependent upon said ambient temperature.

2. The method of claim 1, wherein setting step comprising the steps of:
if the ambient temperature is below a first temperature, then setting said state of charge to a first value; and
if the ambient temperature is above a second temperature, said second temperature being greater than or equal to said first temperature, then setting said state of charge to a second value less than said first value.

3. The method of claim 2, wherein said second temperature is equal to said first temperature.

4. The method of claim 2, wherein the first value of said state of charge is greater than 70%.

5. The method of claim 2, wherein the first value of said state of charge is between 70% and 90%.

6. The method of claim 4, wherein the second value of said state of charge is less than 60%.

7. The method of claim 5, wherein the second value of said state of charge is between 40% and 60%.

8. A method of operating a nickel-metal hydride battery, comprising:
providing said nickel-metal hydride battery, said battery being at an ambient temperature of −20° C. or less; and
converting a portion of the chemical energy of said battery to thermal energy.

9. The method of claim 8, wherein said converting step decreases the charge transfer resistance of said battery.

10. The method of claim 9, wherein said converting step comprises the step of discharging said battery.

11. The method of claim 10, wherein said discharging step comprising the step of applying a short circuit across said battery for a finite period of time.

12. The method of claim 8, wherein said battery is provided having a temperature of −25° C. or less.

13. The method of claim 8, wherein said battery is provided having a temperature of −30° C. or less.

14. The method of claim 11, wherein said short circuit is applied for 10 seconds or less.

15. A method of operating a nickel-metal hydride battery to apply power to a load, comprising the steps of:
providing said nickel-metal hydride battery;
applying a short circuit across the terminals of said battery for a finite period of time;
after applying said short circuit, electrically coupling said battery to said load.

16. The method of claim 15, wherein said short circuit is applied while said battery is electrically disconnected from said load.

17. The method of claim 15, wherein said load comprises a starting and/or ignition circuitry of a vehicle.

18. The method of claim 15,wherein said load comprises a lighting circuitry of a vehicle.

19. The method of claim 15, wherein said short circuit is applied for 10 seconds or less.
